(19) United States
(12) Patent Application Publication
(10) Pub. No.: US 2007/0218983 A1
(43) Pub. Date: Sep. 20, 2007

(54) Progressive gaming systems and methods

(76) Inventor: Charles Lombardo, Henderson, NV (US)

Correspondence Address: WEIDE & MILLER, LTD., 7251 W. LAKE MEAD BLVD., SUITE 530, LAS VEGAS, NV, 89128, US

(21) Appl. No.: 11/376,773

(22) Filed: Mar. 15, 2006

(51) Int. Cl. A63F 1/00; G06F 19/00

(52) U.S. Cl. 463/27; 273/292

(57) ABSTRACT

In a method of game play, if a player places a qualifying wager, the player is permitted the opportunity to play for a progressive jackpot or award. Players placing qualifying wagers are permitted to select from a number of game formats, such as games having different base denomination wagers, different active paylines, different wagers per payline, or other configurations. Regardless of the game format, however, each play placing a qualifying wager has the opportunity to win the progressive jackpot. The method may be implemented at a single machine or a progressive system including multiple machines.

### FIELD OF THE INVENTION

The present invention relates to progressive gaming systems and gaming machines offering wagering games with improved opportunities for progressive or other jackpot awards.

### BACKGROUND OF THE INVENTION

In many gaming establishments, such as casinos, players are offered opportunities to win progressive jackpots and/or awards associated with certain gaming machines. One common type of game which may have a progressive jackpot component is a slot-type game. In this game, a player may select pay lines and wager amounts in an attempt to win an award which depends upon symbols which are shown in various positions along the paylines. Typically, a portion of one or more wagers made in multiple linked progressive jackpot games are pooled to provide a substantial progressive jackpot pay out. All or a portion of that jackpot may be awarded if the player receives a particular winning symbol combination. While a progressive jackpot can be generated at and be associated with a particular gaming machine, to make the jackpots larger, numerous machines are typically associated with one another in a “progressive system.”

Currently, player eligibility for a progressive jackpot win is determined by the wager placed by the player. This eligibility may be determined or defined in a number of ways.

In one method, a player may be eligible only if they change their bet and place a bet greater than a threshold bet which is required to play the game. For example, while a player may be permitted to play a game by placing a single coin bet (like $0.25), the player may be require to increase their bet to a five coin bet (such as $1.25) in order to be eligible to win the progressive jackpot. Any bet less than the five coin bet may cause the player to be ineligible to win the progressive jackpot.

In another method, selection of all possible pay lines may be necessary to be eligible for a progressive jackpot. For example, if nine pay lines are displayed, a player wagering on less than all nine pay lines would be ineligible for a progressive jackpot.

In another variation of a method, a combination of threshold bets together with selection of all possible pay lines may define a player's eligibility in a progressive jackpot game. For example, to be eligible for a progressive jackpot, if each pay line permitted a maximum bet of five coins and the number of pay lines was nine, a total of forty-five coins would need to be played (five coins for each of nine play lines).

Generally, a particular progressive jackpot is associated with gaming machines of the same type or offering the same game. For example, different progressive jackpots are associated with machines which offer games based upon different bet denominations. Thus, gaming machines offering game play for a $0.05 wager offer a different progressive jackpot than those machines offering game play for $1.00 wagers. In general, the progressive jackpot in the latter case will be greater than that in the former case because a larger amount of the wager can be associated with the progressive jackpot each time a wager is made.

Many players are averse to gaming machines where very large maximum bets played on every pay line qualifies the player to win a progressive jackpot. For example, players quickly realize that a penny gaming machine with a wager requirement of five coins per line playing twenty pay lines to play for the progressive jackpot is equivalent to playing a dollar for each round of play. Moreover, many players find undesirable the variation in progressive jackpot size relative to wager size. For example, a progressive jackpot on a $0.05 wager machine may be low because of was just hit, while the jackpot on a $1.00 wager machine may be very large because it has not been won for some time, but to play the latter game, the player must place a wager which is 20 times larger. Such players may feel as though they are unequal participants in jackpot games and therefore be more reluctant to play based on budgetary and perception considerations.

Improved award methods are desirable where player's negative perceptions of progressive jackpot games are overcome. Such methods may encourage greater play of progressive jackpot machines and increase revenue for gaming establishments.

### SUMMARY OF THE INVENTION

Embodiments of methods of game play, gaming machines and systems including gaming machines are disclosed. In general, the invention comprises methods of game play offering bonus wins, and preferably progressive-type jackpots, and gaming machines and systems configured to present the games and generate the progressive jackpots.

In one embodiment of a method of game play, one or more players are offered the opportunity to play, upon placing a qualifying wager or bet, a game in at least two different formats. The game formats may differ by at least one of: wager denomination, number of wagered paylines and wager per payline or other game play features. Each player who places a qualifying wager, regardless of the selected game format, however, is provided the opportunity to play for a common progressive bonus.

In accordance with the method, a wager or bet is accepted from a player. If that wager or bet is not a qualifying wager, then the player may still be permitted to play the game, but the player is preferably not provided the opportunity to win the progressive bonus. If, however, the wager is a qualifying wager, then the player is preferably presented with game format options. Once a game format option is selected and accepted, the one or more games are presented in accordance with the selected format(s). The outcome of the game(s) is determined and, if the outcome is a progressive bonus winning outcome and the player placed a qualifying wager, the player is awarded the progressive bonus.

In one embodiment, if the player did not place a qualifying wager or the player did not receive the progressive winning outcome, the player may still be awarded winnings for other predetermined winning outcomes, such as in accordance with a paytable.

The method of play may be implemented at a single gaming machine or a system including a plurality of gaming machines. In a preferred embodiment, a portion of all wager or all qualifying wagers is preferably distributed to a progressive pool from which the progressive bonus is awarded. In this manner, the progressive bonus increases based upon game play (so long as the award is not paid).

In one embodiment, the game is a reel or video-type slot game. In that configuration, a player may be presented with game formats which allow the player to select the base denomination of wager for the game, the number of paylines to play or activate, and/or the size of wager per payline. Other game format options may include multiplier games, game with differing numbers of active reels and the like. Regardless of the game format, however, each player has the opportunity to win the same progressive award.

In a preferred embodiment, the qualifying wager is greater than the minimum wager which may be placed to play a game, but less than the maximum wager which may be placed to play a game.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a gaming machine in accordance with the present invention;

FIG. 2 is a block diagram of a system for implementation of the present invention; and

FIG. 3 illustrates a flow diagram of an exemplary method of implementing the present invention.

### DETAILED DESCRIPTION OF THE INVENTION

A gaming machine, methods of playing a wagering based game at one or more gaming machines with the opportunity for a progressive or jackpot award, and a progressive system including multiple gaming machines or interconnected games, are disclosed. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the present invention comprises a gaming machine, a system including one or more gaming machines, and methods of presenting and playing games. In one embodiment, a gaming machine is configured to present a wagering game. A player is provided the opportunity to win a progressive award or a jackpot. In one embodiment, the progressive award or jackpot is an award which is not paytable-dependent, and thus not fixed, but is one which changes over time. Preferably, the size of the progressive award increases over time, such as depending at least in part upon wagers which are placed at the one or more gaming machines. The progressive jackpot may be funded by at least a portion of certain wagers at the one or more gaming machines such that, when the jackpot is not won, the progressive jackpot increments or grows as wagers are placed.

One aspect of the invention is a progressive system including multiple gaming machines. In accordance with the invention, a player of a gaming machine is provided the opportunity to play for a progressive award or jackpot by placing a wager of a fixed amount. The fixed wager amount is preferably less than the maximum amount which may be wagered by the player to play the game. Further, a player placing such a wager is offered the opportunity to play different games or games having different formats. In an embodiment of the invention, in an attempt to win the progressive award or jackpot, the denomination of the wager associated with a game may determine availability of different games.

1. Gaming Devices

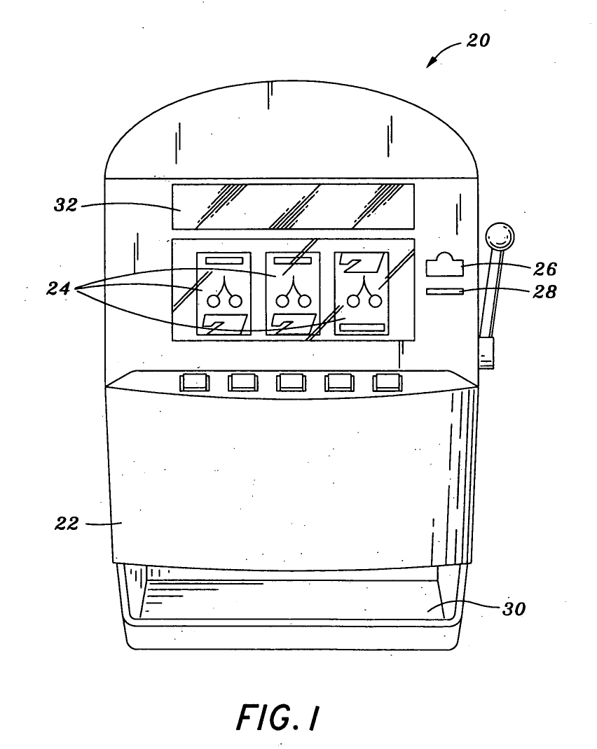

Referring to FIG. 1, there is illustrated a gaming machine 20 in accordance with one embodiment of the present invention. In general, the gaming machine 20 is adapted to present one or more games for play to a player. As illustrated, the gaming machine 20 comprises a housing or cabinet 22 for supporting and/or housing various components of the gaming machine 20. In the embodiment illustrated, the gaming machine 20 is adapted to present a game of slots and includes one or more rotatable reels 24. In another embodiment, the gaming machine 20 may be configured as a video-type machine and include other components, such as a video display.

Preferably, the gaming machine 20 is configured to present one or more games to a player dependent upon a player placing a wager or bet, and in the event the outcome of the game is one or more predefined winning outcomes, pay the player a winning. As such, the gaming machine 20 includes a mechanism for accepting a wager or a bet. As illustrated, a coin acceptor 26 is provided for accepting coins. The gaming machine 20 also as illustrated includes a bill acceptor or validator 28 for accepting paper currency. In one or more embodiments, other mechanisms may be provided for accepting a wager, such as a card or ticket reader.

The gaming machine 20 may include a variety of other components, as are known. For example, the gaming machine 20 may include a plurality of input devices. These input devices may include one or more buttons, such as a “play credit” button and/or a “bet max” button for permitting a player to place wagers from a pool of credits won or paid by the player. The input devices may include a “spin reels” button or a pull-type handle for effecting the spinning of the reels.

When value is provided to the gaming machine 20, the gaming machine 20 may be configured to display information regarding the provided value, such as in the form of “credit” information. This information may be displayed, for example, on a display of the gaming machine or one associated therewith.

In a preferred embodiment, a player is awarded a payout in the event the outcome of the game is a winning outcome. In one or more embodiments, the amount of the award is based on the amount wagered by the player and/or the odds of receiving the particular outcome. The payout may comprise credit, actual monies or other items of value or representative of value, such as a ticket or a physical prize.

When the player is paid in the form of stored credits, the number of credits is indicated to the player. A “cash out” button is preferably provided for permitting a player to be paid the stored credits. In one embodiment, the means for paying a player comprises a coin dispenser (not shown) for dispensing coins to a coin tray 30. A player may also be permitted to be paid their credits or winnings on a player card in electronic form, such as via a card reader/writer.

It should be understood that the gaming machine 20 may be adapted to present one or more of a wide variety of games. Depending upon the game presented, the configuration of the machine may vary. For example, in the event the gaming machine 20 is adapted to present a game of video poker, the gaming machine 20 may include a display (not shown) for displaying images of cards and other information.

In a preferred variation, the gaming machine 20 may be configured as a “slot” type gaming machine. In such a configuration, the gaming machine 20 may include one or more reels comprising bodies having one or more indicia or symbols printed thereon. The reels may have a number of positions or locations which bear or do not bear (i.e. comprise a “blank” position) indicia. The indicia or symbols which are borne by the reels may vary.

In such a configuration, the various combinations of indicia displayed by the reels preferably have significance to or relate to the outcome of a game presented at the machine 20. For example, certain combinations of indicia may comprise a non-winning combination. Preferably, one or more combinations of the indicia when displayed as a result of a spin of the reels are designated as a winning combination of indicia. The number of winning combinations may vary dependent upon the desired payout or winning percentage to the players as compared to that which is retained by the game operator. Means are provided for rotating the reels. In one or more embodiments, the means may comprise a mechanical linkage associated with a spin arm, with movement of a spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference.

The gaming machine 20 may also be configured as a “video” slot machine in which the symbols are displayed by one more or video displays, rather than mechanical reels. In such an embodiment, the “reels” are generally video simulated graphic representations of actual reels. In that configuration, the gaming machine 20 may include one or more video displays, such as CRT, plasma, LCD or other types of devices now known or later developed for generating visual graphic information.

In a preferred embodiment of the invention, the gaming machine 20 may include a variety of other components and features. For example, the gaming machine 20 may include a speaker 32. The speaker 32 allows for audible information to be presented.

It will be appreciated that the term gaming machine as used herein may apply to a variety of devices other than a gaming machine as illustrated in FIG. 1. That is in one or more embodiments, the term gaming machine may apply to a wide variety of devices or systems that are adapted to present a game to a player. For example, the device may comprise an arcade game, or a computing device configured to present a game, such as a player's home computer which is connected to a game server by a communication link. The gaming machine may be of the upright, bar-top or other variety, and may be located in a casino or other location. In one or more embodiments, the gaming machine need not be configured to pay winnings. For example, the game may be played for fun or prizes. In such event, the player may be permitted to play the game for free or may be required to make payment to play the game. Instead of being awarded monetary winnings (or representations thereof, such as credits which may be redeemed for representative monies), the player may be awarded points, tokens, physical goods, discounts and other value.

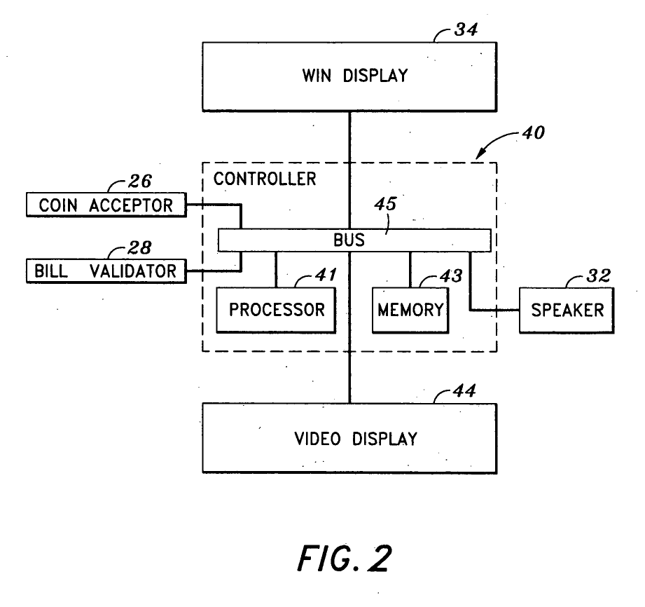

In a preferred embodiment, the gaming machine 20 includes a master gaming controller 40 (see FIG. 2 and description below). In general, the master gaming controller 40 is configured to generate information for controlling the operation of the gaming machine 20, including the various peripheral devices such as buttons, reels 24, etc. for the included purposes of presenting a game.

As indicated above, a player may provide value to the gaming machine 20 or machine operator in a number of ways, including with coins or bills. The player might also be permitted to provide value remotely. Value provided to the gaming machine 20 may be represented as credits. Each credit may have an associated monetary value. Once the player provides value, the player preferably places a wager to play the game. This may be accomplished, in one embodiment, by the player pressing a “bet one” button (not shown) or a “bet max” button (not shown), or by other means.

One embodiment of a master gaming controller 40 is illustrated in FIG. 2. The gaming controller 40 may have, however, a variety of configurations other than that illustrated. In one embodiment, the controller 40 includes a processor or processing device 41. In general, the processing device comprises a device capable of executing readable program code or data. In another embodiment, the processing device may comprise hardware which embodies the program code or data.

In a preferred embodiment, program code for use by the processing device 41 may be stored in a memory 43 or other information storage device for storing data. The processing device 41 and memory 43 are in communication with one another. In one embodiment, the processing device 41 and memory 43 are linked by a common system bus 45. The operation of the bus 45 is well known.

As detailed, the controller 40 is configured to control the various peripheral devices of the gaming machine 20. As such, in a preferred embodiment, the processing device 41 is preferably capable of receiving information or data from the peripherals, and send information or data, such as instructions, to those devices. As illustrated, in one or more embodiments, the coin acceptor 26 and bill validator 28 communicate with the processing device 41 via the bus 45. The other peripherals, such as the reels 24 and/or a video display 44 are coupled to the bus 45.

As indicated above, in one embodiment, the gaming machine 20 includes reels 24. The reels 24 (or their control motors) may be associated with the controller 40, and more particularly, the processing device 42. This association permits the controller 40, upon a winning event, to cause the reels 24 to display game information.

In one embodiment, the master gaming controller 40 may be associated with a player tracking system or other system. For example, the master gaming controller 40 may be associated with a security or game service system. This system may include one or more remote devices, such as one or more remote servers, such as for generating and transmitting game implementing software. These devices may be placed in communication with the master gaming controller 40 via a communication interface at the gaming machine 20. The communication interface may couple to the bus 45. A communication link, such as a wired or wireless link, is provided between the communication interface and the remote device, such as a communication interface of a remote server.

The player tracking system may comprise a system for tracking aspects of a player's game play at the gaming machine 20. The system may include one or more devices located at the gaming machine 20 itself, such as a media reader. The media reader may comprise, for example, a magnetic stripe card reader for reading information from a magnetic stripe of a player card. The reader may utilize information obtained from the player's media, such as player tracking card. This information may be transmitted to the remote host, such as a player tracking system host, to obtain information regarding the player of the gaming machine 20, and to track information regarding the player's play provided by the gaming machine.

It will be appreciated that the gaming machine 20 may have a variety of configurations, and that the gaming machine 20 illustrated and described above is but an example of a device for implementing the game of the present invention. For example, in one or more embodiments, the gaming machine 20 may be associated with a network and receive game information remotely and may transmit information, such as payout and game play information, to a remote location. For example, a remote master controller may generate game information which is transmitted over a communication link to the gaming machine 20. That information may be utilized by a local controller or processor to present the game, such as by displaying game play data or information. The gaming machine 20 might also comprise a computer, such as a desktop or laptop computer, which computer might receive game information from a remote gaming server or controller over a communication link.

It will be appreciated that in one or more embodiments, the gaming controller 40 of the gaming machine 20 is specifically configured to implement the method of the present invention. In this regard, machine readable program code may be provided, such as stored in memory, for this purpose. In another embodiment, the processor may be specifically configured to implement all or a portion of the method.

2. Methods of Game Presentation/Play

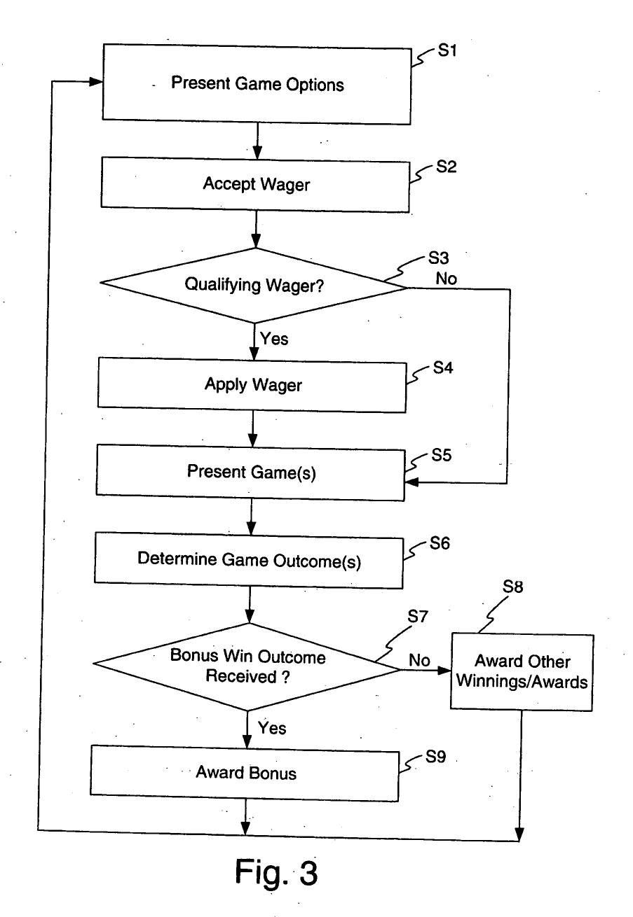

A method in accordance with one embodiment of the invention will now be described with reference to FIG. 3. It will be appreciated that the steps of this exemplary method may be performed in any suitable order or manner.

In a preferred embodiment, the game involves an opportunity to win a bonus win or award. In one embodiment, as described below, the opportunity to win a bonus award depends upon one or more criteria, such as whether a player places a qualifying wager and whether the player receives a particular game outcome. The bonus win or award may be referred to as a jackpot, jackpot winning or jackpot award (or other terminology), since, in a preferred embodiment, the size of the bonus award may be larger than one or more other awards which may be won as a result of playing the game.

In the preferred embodiment, the bonus win is paid, at least in part, from a fund or pool. Wagers are preferably used, at one or more times, to fund the pool. In a preferred embodiment, the pool is configured as a progressive pool, and in such a configuration the award may then be referred to as a progressive award or jackpot. As such, the size or value of the pool, and thus the associated potential bonus award, increases over time (preferably, based upon game play frequency). When a bet or wager is accepted, the pool is preferably incremented. In one embodiment, the size of the pool may be increased based upon all bets, and in another embodiment, only when a qualifying bet or wager is placed, as detailed below.

Referring to FIG. 3, in a step S1, one or more games may be offered to one or more players. The games may be configured to offer player selectable options or in various game formats. For example, the games may be of various types, such as conventional single or multiple pay line slot games. The game or games may also be configured as video poker, blackjack, keno, roulette or a variety of other games now known or later developed. The one or more games may be offered in stand alone or any other suitable configurations as described above.

In a preferred embodiment the games are configured to offer a progressive jackpot win (or award) based on a qualifying wager (or bet). The qualifying wager (or bet) may be a predetermined wager amount required for entry into a progressive jackpot game. For example, a $5.00 bet may be such a bet. In one embodiment, a portion (say 5 cents) of the qualifying wager is accumulated in a jackpot bonus win or award. A portion of each qualifying wager may be distributed as winnings to one or more winning players of the games and as profits to one or more operators of the games.

In one embodiment, the game may have a plurality of outcomes. One or more of those outcomes may be declared as winning outcomes. A bonus award may be paid for one or more of the winning outcomes. A non-bonus award, such as a fixed award based upon a paytable, may be awarded for other of the winning outcomes.

In one embodiment, the player may be permitted to place wagers or bets of various amounts to play the game. In a preferred embodiment, the qualifying wager may be greater than a base or minimum wager which is required to play the game, and less than a maximum or largest wager which may be placed.

In one embodiment, if the player places a wager or bet in an amount other than the qualifying wager, then the player is preferably permitted to play the game, but the player is not permitted to win the bonus win or award, even if the player receives one of the winning outcomes which otherwise yields the bonus award.

In step S2, a bet or wager is accepted. The player may place a bet or wager in a number of ways, such as by inputting monies to the gaming machine 20 or betting credits which belonging to the player.

In a step S3, it is determined whether the player placed a qualifying wager. If not, then the player has not placed a wager which entitles the player to play for the bonus win or award, and the player plays the game without that opportunity (as in step S5 illustrated therein).

If so, then in a step S4, the qualifying wager (or bet) is applied to one or more player selectable games or “game formats.” Each of the games may be configured with player selectable wager options or the player may be permitted to select from various pre-configured game formats. Preferably, the player selectable wager options may comprise one or more of: a denomination of wager; a number of paylines, hands or other game element; and a size of wager upon each payline, hand or other game element. In one embodiment, a player may be presented with a plurality of game formats, at least two of the formats comprising games having one or more of: a different base wager or bet denomination; a different number of active paylines, hands or other game elements; and different size of wager upon each payline, hand or other game element.

In one example, the player selectable wager option may be a decision about which and how many denominational bet units are to be distributed to one or more games. A denominational bet unit may be a wager sufficient to initiate play of a particular game (i.e. a minimum bet). For example, if the qualifying wager is $5.00, a player may distribute $5.00 to a number of games with available denominational bet units (or wagers) ranging from one cent to $5.00. A one cent denominational bet unit game may have 100 pay lines and the player may select one or more of the 100 pay lines. Alternatively, the game may have 10 pay lines with (for example) up to ten denominational bet units per pay line and each denominational bet unit valued at five cents for a possible distribution of a total of $5.00 to all available pay lines. In one example, to further illustrate possible player distributions, the player may select to distribute $1.00 of the qualifying $5.00 wager to a one cent game associated with any number of available pay lines, $3.00 of the $5.00 wager to each of three paylines of a $1.00 per line denomination slot game, and the remaining $1.00 of the $5.00 wager in yet another slot game with a ten cent denominational bet unit associated with 5 pay lines and 2 ten cent bets allocated to each pay line of the slot game. Of course, the game may be configured so that the number of denominational bet units associated with any bet line may also be variable. Further examples of variations in player selectable wager (or bet) distributions are discussed below.

In step S5, after accepting a player's non-qualifying wager or their qualifying wager and initial wager selections for particular games or game formats, the one or more games are presented. In the instance where the player placed a qualifying wager and that wager was applied to more than one game, those games are presented.

In step S6, it is determined if the outcome of any of the games was a winning outcome. As indicated above, one or more possible game outcomes may be designated winning outcomes.

In a step S7, it is determined if any bonus winning outcomes were received. As indicated above, if the player did not place a qualifying bet, then the player can not participate in a bonus win. Thus, if the player did not place a qualifying bet or the winning outcome was not a bonus winning outcome, then in a step S8, it is determined if the outcome was a winning outcome and associated winnings (if any) are awarded. As detailed above, certain winning outcomes may yield an award in accordance with a paytable (i.e. predetermined award amount). Particular winning outcomes might also or instead yield other types of awards, such as additional free game play (such as free spins) or the like.

If in step S6 the outcome of the game or games was a bonus win outcome (i.e. the player placed a qualifying bet and the outcome of the game or games was a bonus winning outcome), then in a step S9, a bonus win is awarded. In one embodiment, one or more progressive jackpot awards may be won according to the platforms associated with games offered to players (see below for further discussion of other embodiments and features).

After the outcomes of all games are determined, a player may elect to play an additional game or games, as in step S1 described above, or the player may elect to stop playing.

3. Aspects of the Invention

In a preferred embodiment of a game of the invention, a player is permitted to play a game with the opportunity to win a bonus win or progressive, without regard to whether the player places the maximum permissible bet or makes a bet on each and every possible betting proposition. Instead, the player is permitted to play for the bonus or progressive by placing a qualifying wager, which wager comprises a fixed amount, and which amount is independent of the denomination of bet, number of betting lines or the like, which apply to a particular game.

In a preferred embodiment, a player is permitted to apply a qualifying wager to one or more games having one or more different formats or configurations. The wager may be applied based upon wagering criteria or to game formats differing by criteria such as the denomination of wager, number of lines to be wagered upon and wager or bet per payline or hand.

For example, a qualifying wager of $2.00 may be distributed in one or more denominational bet units to any or all pay lines of multiple pay line games offered to a player. In one game the $2.00 qualifying bet may be distributed on 200 pay lines at one cent per line, 100 pay lines at two cents per line, 40 pay lines at five cents per line, 20 pay lines at ten cents per line, 8 pay lines at twenty-five cents per line, 4 pay lines at fifty cents per line, 2 pay lines at one dollar per line or 1 pay line at two dollars on the one line. Of course, in a 25 pay lines game with a denominational bet unit of ten cents and an initial player's bet of $2.00, the player would be limited to only playing 20 pay lines of the pay lines game, should the player choose to only play that game.

Preferably, however, though the qualifying wager may be applied in different manners as to different games, all players who place a qualifying wager are preferably entitled to play for the same bonus win, such as the same bonus progressive. For example, player A may place a qualifying wager of $3.00 and distribute that wager to a game with a $1.00 bet denomination, with $1.00 bet on each of 3 paylines. Player B may place the same qualifying wager of $3.00 and distribute that wager to a game with a $0.01 denomination, with $0.03 bet on each of 100 possible paylines. Players A and B, however, are both entitled to play for the same progressive jackpot and entitled to win that jackpot if a jackpot winning outcome for their game is received.

Preferably, the odds of a player receiving the bonus or progressive win is the same for all games. It will be appreciated that the size of the award for various other winning combinations and/or the number of other winning combinations may vary.

In other embodiments of the invention, various selectable game options of one or more games or the different game formats may be offered with an opportunity to win one or more common progressive jackpots and/or awards to enhance player experience and excitement during play of the games. Besides selection of total quantity of lines based on a qualifying bet, examples of various selectable game options may include select of games or game formats with multipliers, buy a pay, quantity of reels in play, quantity of pay lines in play and quantity of coins (or denominational bet units) wagered per pay line, as is well known by persons skilled in the art.

In one example of an embodiment of a fixed qualifying wager distribution with various selectable game betting options or game formats, a $5.00 qualifying bet is made by the player. The $5.00 bet may be distributed in accordance with the following options or game formats: the $5.00 bet may be twenty-five cents per line (made up of 5 five cent coins) on a five reel game with 20 pay lines; one dollar and twenty-five cents per line (made up of 5 twenty-five cent coins or credits) on a three reel game with 5 pay lines; or fifty cents per line (made up of a single fifty cent coin or credit) on a five reel game with 10 pay lines and so on.

In another example embodiment with betting variables, a $5.00 bet may be placed by a player. In the following examples, the player may select to distribute the $5.00 bet in any or all of the following ways or to the following game formats, based on distributing $1.00 bet units (or $1.00 denominational bet units). Of course, a player may be permitted to distribute the $5.00 bet in larger or smaller denominational bet units (that is from 1 cent to the entire $5.00 bet provided that the entire $5.00 bet is distributed). In yet another embodiment, it is contemplated that more than a qualifying bet may be placed, and optionally a portion of the greater qualifying bet may be used in one or more rounds of player selected games.

Initially, the player may bet $1.00 denominational bet units on a game or game format with five reels and five pay lines. The player may place $1.00 units on all or less than all of the pay lines. If a pay line displays (or hits) a predefined selection of jackpot indicia, and the player had selected the pay line, the player is awarded a progressive jackpot award from a predefined pay table. Of course, the player may receive less than the jackpot award according to the pay table if other indicia are displayed. The term indicia refers to symbols such as cherries, bar symbols, thematic game symbols and so on as is well understood in the art.

A second game may comprise a three reel five coin “buy a pay” with one denominational bet unit (coin, token, credit and the like) wagered per way and a single pay line. For example, the player may distribute the entire $5.00 bet or subdivide a portion of the $5.00 bet into five 50 cent bets (for a total of $2.50 bet) to play the three reel five coin “buy a pay” game. The remaining balance of $2.50 may be distributed in other games offered to the player. Again, if the player's selection of the bet per way on the single pay line matches a selection of jackpot indicia according to a predefined pay table, the player would receive a progressive jackpot award. Other indicia may provide different awards to the player as is well understood in the art.

A third game may comprise a three reel game with a fourth reel bonus/five denominational bet unit “multiplier” and a single pay line. Thus, if the player places a $1.00 bet and the three reels plus the fourth bonus multiplier line up on the player selected pay line, the player is awarded a five times multiplier based on a predefined pay table. The player may also receive other awards as is well understood in the art. However, if the reels and the fourth bonus multiplier display a predefined selection of jackpot indicia on the pay line the player may receive a progressive jackpot or award.

In another embodiment several commonly linked different platforms (formats or types) and/or options of games may offered to a player. The player distributes a portion of a fixed denomination bet to the variety of games as described above. In these embodiments, percentage pay outs received by players may vary according to each game theme or each game's denominational unit basis. In this embodiment, preferably the odds of winning a super progressive jackpot win or award is equal on all commonly linked offered games.

In one example, progressive games are linked and multiple denominational bet unit options may be selected (tendered or offered) by players. Thus, $1.00 denominational bet unit games and one cent denominational bet unit games may be linked to create a common progressive jackpot opportunity. A player may select to distribute a $5.00 bet to three different games such as a five cents game, a $1.00 game and a $5.00 game. All of these games may have different game themes and may be linked to a progressive jackpot. When the player hits a predefined winning result, the player receives a progressive super jackpot win or award according to a predetermined pay table.

In a second example, a player may select to only play in games with a common game theme. These common theme games may be linked in a progressive game network. When the player hits one or a combination of winning results, the player receives the progressive jackpot win or award. Of course, a combination of games with a common theme and games without common themes may also be linked in a progressive jackpot arrangement. In this case (or scenario) a player wins a super progressive jackpot award according to a predetermined pay table for the linked games.

In a third example, a stand alone game machine offering multiple denominational bet unit games or game formats may provide a progressive jackpot win or award. In this example, a player selects one or more games with a player selectable denominational bet unit on a stand alone machine. The machine offers games with multiple denominational bet units. The player places an initial bet of $2.00 to be distributed to one or more of the multiple denominational bet unit games. Every player of the machine may win a progressive jackpot win or award irrespective of the player's selected denominational bet units. Thus if the machine's games offer denominational bet units ranging from one cent to $1.00 and the player's $2.00 qualifying bet is distributed according to the player's distribution decision to one or more of the pay lines of the offered games, a progressive jackpot win or award may be won by the player.

In a fourth example, a stand alone game machine offering different multiple games and/or multiple player selectable denominational bet units may also provide a progressive jackpot win or award. In this example, a player selects one or more different games and/or player selectable denominational bet units on a stand alone machine. Every player of the machine may win a progressive jackpot win or award irrespective of the player selectable denominational bet units or game themes. For example, the machine may offer one or more conventional slot machine games and one or more poker games. Each of the games may also offer multiple denominational bet units ranging from twenty-five cents to $5.00. The player's qualifying bet may be $25.00 to be distributed to one or more of the offered games. A progressive jackpot win or award may be won by the player in any one or any combination of games. Of course, any combination of one or more stand alone machines or linked progressive game machines including different multiple player selectable games and different multiple player selectable denominational bet units may provide a progressive jackpot win or award as described above.

A player may be provided the opportunity to play for more than one award, such as a base payout and a top progressive award, or a game progressive and a top progressive award. For example, by placing a wager of a particular amount, such as $5.00, the player may automatically qualify to play for the top or common progressive award. When the player allocates that $5.00 wager, such as by wagering $1.00 on each of five $1.00 denomination games, the player may also be provided the opportunity to win a progressive award associated with either the particular machine being played, the particular game (i.e. progressives might be associated with particular games offered by the machine or particular games offered by multiple machines), or the base denomination wager (i.e. a progressive award for linked $1.00 wager games). In other words, by placing a qualifying bet or wager, the player may not only qualify to potentially win the top progressive or award, but may be eligible to win other awards, such as the awards which would be available to the player if the player only placed a wager to play the game and not a qualifying wager.

While in a preferred embodiment the player is presented with the opportunity to place a qualifying wager or another wager (such as a non-qualifying wager between a minimum and maximum amount), in other embodiments, the player may only be permitted to place a wager of a qualifying amount. In that instance, all players may place the same wager, but each player then has two or more different game formats to choose from, in the manner described above.

One aspect of the invention is a progressive system including a plurality of gaming machines.

In one embodiment, a number of gaming machines offering the above-referenced game or games are associated with one another, either directly or through one or more common components, such as a system or progressive host. In a “host” configuration, a progressive controller may monitor qualifying wagers at the various gaming machines of the system, increment the one or more progressive bonus awards (which amount or amounts may be displayed at the gaming machines, at independent machines or the like, and including removing a “house” portion of allocated wagers), and award the progressive award to the player of a gaming machine at which the bonus or progressive outcome is received. Of course, such systems are known and may have a variety of hardware and software configurations.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A game play method comprising the steps of:
accepting a wager between a minimum amount and a maximum amount;
if said wager is a qualifying amount between said minimum amount and said maximum amount, presenting at least one game selected from games having at least two game play formats to said player, one or more of said game formats differing by at least one of the group consisting of:
denomination of wager, number of paylines wagered and wager per payline;
accepting a game format selection from said player;
presenting at least one game in accordance with said game format, said at least one game having a plurality of possible outcomes, at least one outcome comprising a progressive bonus winning outcome;
determining the outcome of said game; and
if said wager was a qualifying amount, determining if said outcome was said progressive winning outcome and, if so, awarding a progressive bonus win.

2. The game play method in accordance with claim 1 wherein said game is a slot-type game.

3. The game play method in accordance with claim 1 including the step of allocating at least a portion of each wager of a qualifying amount to a progressive jackpot pool and wherein said progressive bonus win is paid from said progressive jackpot pool.

4. The game play method in accordance with claim 1 including the step of awarding an award for a game winning outcome other than said progressive bonus winning outcome.

5. A method of game play comprising the steps of:
offering at least two games having formats differing by at least one of: wager denomination, number of wagered paylines and wager per payline; where for a qualifying wager of a fixed amount placed to play any of said at least two games, said player is entitled to win the same progressive bonus win if that player receives a predetermined winning outcome for the game which is played;
accepting a wager from the player and, if the wager is a qualifying wager, accepting input regarding the game format;
presenting the game in accordance with any game format selected by the player;
determining the outcome of said game; and
if the outcome of said game is a predetermined winning outcome for that game, awarding said player said progressive bonus.

6. The method of game play in accordance with claim 5 wherein each of said games having differing formats comprises a slot-type game.

7. The method of game play in accordance with claim 5 wherein said qualifying wager is between a minimum wager and a maximum wager available to play said game.

8. A method of game play comprising the steps of:
accepting a qualifying wager from a player;
presenting said player with the opportunity to play a slot-type game in at least two different formats, said at least two game wager formats differing by one or more of base wager denomination, number of active paylines and wager per payline, with the total wager for each different game format totaling the qualifying wager;
assigning at least a portion of each qualifying wager to a common progressive pool;
accepting a game format selection from said player;
presenting to said player said game in accordance with said selected game format;
determining if the outcome of said game is a jackpot winning outcome and, if so, awarding the player a progressive jackpot award from said progressive pool, said progressive jackpot being of the same value regardless of the game format selected by the player.

9. The method of game play in accordance with claim 8 wherein said game is presented at a gaming machine.

10. The method of game play in accordance with claim 8 wherein said game is a video slot-type game.

11. The method of game play in accordance with claim 8 including the step of presenting said game at a plurality of gaming machines which are linked to one another.
